(19) United States
(12) Patent Application Publication
(10) Pub. No.: US 2014/0305862 A1
(43) Pub. Date: Oct. 16, 2014

(54) BACK-FLUSH FILTER SYSTEMS AND MECHANISMS THEREFOR

(71) Applicant: AMIAD WATER SYSTEMS LTD., D.N. Upper Galil 1 (IL)

(72) Inventors: Boaz Zur, DN Bikat Beit Hakerem (IL); Rudolph Kaner, Karmiel (IL); Ruven Shtekelmacher, Korazim (IL); Avi Levi, Moshav Yodfat (IL); Tzur Bobrov, Kfar Kish (IL); Ud Mussel, D.N. Lower Galilee (IL); Amir Ziv-Av, Kiryat Ono (IL); Dvir Brand, Kfar-Saba (IL)

(73) Assignee: AMIAD WATER SYSTEMS LTD., D.N. Upper Galil 1 (IL)

(21) Appl. No.: 14/350,582

(22) PCT Filed: Oct. 11, 2012
(86) PCT No.: PCT/IL2012/050403

§ 371 Date: Apr. 9, 2014

Related U.S. Application Data
(60) Provisional application No. 61/545,769, filed on Oct. 11, 2011.

(51) Int. Cl. B01D 29/68

(52) U.S. Cl. CPC B01D 29/68
USPC 210/333.01

(57) ABSTRACT

Provided is a filtration system including a filter housing having an inlet port and an outlet port. A plurality of filtration units are disposed within the filter housing. The system can further include at least one cleaning system configured for cleaning at least one filtration unit of the plurality of filtration units and at least one drive unit. The at least one drive unit can be configured for displacing one or both of said at least one filtration unit of the filtration units and the at least one cleaning system with respect to the other of said at least one filtration unit of the filtration units and said at least one cleaning system.

### TECHNOLOGICAL FIELD

This disclosed subject matter relates to fluid filtration systems. More particularly the disclosure is concerned with back-flush filter systems configured with a plurality of filtration units. The term back-flush filter is also referred to as backwash filter.

The disclosed subject matter further relates to a transmission mechanism for such filtration systems.

### PRIOR ART

References considered to be relevant as background to the presently disclosed subject matter are listed below:
U.S. Pat. No. 4,642,188
U.S. Pat. No. 4,906,373
U.S. Pat. No. 5,855,799

Acknowledgement of the above references herein is not to be inferred as meaning that these are in any way relevant to the patentability of the presently disclosed subject matter.

### BACKGROUND

U.S. Pat. No. 4,642,188 discloses a multi-element filter unit which includes backwash apparatus and comprises a filter casing with provision for alternative, oppositely directed process liquid and backwash liquid flows therethrough. A plurality of filter tubes are closely spaced within the filter casing. A flange engages the filter tubes and divides the filter casing into first and second chambers. Apparatus for sequentially backwashing the filter tubes during a backwash interval removes collected solids from between the filter tubes by flow of backwash liquid from one filter tube outward toward the exterior of adjacent filter tubes. The backwash apparatus includes poppet units aligned with open ends of the filter tubes and selectively actuable to close the opposed ends of one of the filter tubes while leaving another open to backwash flow thereinto, such that each filter tube is backwashed in sequence while the others are closed against backwashing liquid flow thereinto, and diffuser structure which apportions, lengthwise of the filter tube, the rate of backwash liquid flow radially out through the wall of each filter tube.

U.S. Pat. No. 4,906,373 discloses a multiple element filter system comprising a filter housing defining a water inlet for water to be filtered, a filtered water outlet, a plurality of cylindrical filter elements, each defining upstream and downstream surfaces, disposed in the filter housing such that the upstream surfaces communicate with the water inlet and the downstream surfaces communicate with the filtered water outlet, and a flushing assembly which includes a movable flushing communication member arranged for selectable flushing communication with the upstream surfaces of each of the plurality of filter elements and apparatus for selectable coupling of the communication member to a flush drain at atmospheric or relatively low pressure.

U.S. Pat. No. 5,855,799 discloses a high capacity filter apparatus for removing solids from fluids and includes an opposing filter element defining an internal volume. Fluid to be filtered passes through the filter elements into the internal volume and through an outlet. The filter element is continuously cleaned by backwashing along the outer surface of the elements.

### GENERAL DESCRIPTION

The disclosed subject matter is concerned, according to a first of its aspects, with a filtration system comprising a plurality of filtration units and a cleaning system, wherein one or both of said filtration units and cleaning system is displaceable with respect to the other of said filtration units and cleaning system.

According to a second aspect of the disclosed subject matter there is provided a transmission mechanism configured for converting motion from one or more drive units to the plurality of filtration units and cleaning system.

According to yet an aspect of the disclosed subject matter there is provided a filtration system comprising a plurality of filtration units, wherein the plurality of filtration units are configured as one or more sub-assemblies comprising a plurality of parallely disposed filtration units. The system further comprises at least one cleaning system configured for cleaning at least one filtration unit of the plurality of filtration units in the one or more sub-assemblies. Also provided is at least one drive unit associated with each of the one or more sub-assemblies, the at least one drive unit being configured with a transmission mechanism. The at least one drive unit being configured for displacing the one or both of said filtration units and the at least one cleaning system with respect to the other of said filtration units and said at least one cleaning system within each of the one or more sub-assemblies.

Filtration systems according to the disclosed subject matter can comprise a housing having an inlet port and an outlet port. The housing can be further configured with a drain port adapted to be closed during a filtration process and to be opened during the cleaning process.

The plurality of filtration units can be parallely disposed within the housing. The cleaning system in accordance with an embodiment can be received within each of the plurality of the filtration units. The cleaning system is configured for cleaning at least one filtration unit. The filtration system can further comprise at least one drive unit and a transmission mechanism in conjunction with the at least one drive unit, and configured for displacing one or both of said filtration units and the at least one cleaning system with respect to the other of said filtration units and the at least one cleaning system.

A filtration system in accordance with an aspect of the disclosed subject matter comprises:

a filter housing comprising an inlet port and an outlet port;

a plurality of filtration units disposed within the filter housing;

at least one cleaning system configured for cleaning at least one filtration unit of the plurality of filtration units; and

at least one drive unit, wherein the at least one drive unit is configured for displacing one or both of said at least one filtration unit of the filtration units and the at least one cleaning system with respect to the other of said at least one filtration unit of the filtration units and said at least one cleaning system.

A filtration system in accordance with yet an aspect comprises:

a filter housing comprising an inlet port and an outlet port;

a plurality of filtration units, wherein the plurality of filtration units are configured as one or more sub-assemblies comprising a plurality of parallely disposed filtration units;

at least one cleaning system configured for cleaning at least one filtration unit of the plurality of filtration units in the one or more sub-assemblies;

at least one drive unit associated with each of the one or more sub-assemblies, the at least one drive unit being configured with a transmission mechanism, and

wherein the at least one drive unit being configured for displacing the one or both of said filtration units and the at least one cleaning system with respect to the other of said filtration units and said at least one cleaning system within each of the one or more sub-assemblies.

Any one or more of the following features and designs can be applied to the filtration systems or to any one of the other aspects subject of the present application, independently or in combination:
the displacement of the at least one filtration unit of said plurality of filtration units and the at least one cleaning system can be either or both rotatable and linear motion, imparted to either one or both of the at least one filtration unit of the plurality of filtration units and the at least one cleaning system, simultaneously or separately;
the filtration system in accordance with the disclosed subject matter further comprising a transmission mechanism;
the transmission mechanism is associated with the at least one drive unit;
the transmission mechanism can be configured for imparting the at least one cleaning system with linear reciprocal motion and/or combined reciprocal rotary motion;
the transmission mechanism can be configured for converting motion from said at least one drive unit to the at least one of the plurality of filtration units and the at least one cleaning system;
the transmission mechanism can be a planetary gear;
the transmission mechanism, can be a planetary gear configured with one or more speed reduction stages;
the transmission mechanism is a planetary (epicyclic) gear system configured with a sun gear mounted on an input shaft articulated to the at least one drive unit, said sun gear being engaged with a plurality of first pinion gears; said pinion gears being each articulated to a rotation shaft of at least one of the plurality of the filtration units or a cleaning system and configured for imparting rotary motion thereto;
each of the plurality of first pinion gears is engaged with a corresponding second pinion gear coaxially extending and each engaged with third stage gear, each articulated to a rotation shaft of a filtration unit or a cleaning system and configured for imparting rotary motion thereto;
the first pinion gears are internally engaged with a first, static ring gear and with a second gear ring which in turn is externally engaged second pinion gears, each articulated to a rotation shaft of the at least one of the plurality of filtration units or the at least one of the cleaning system and configured for imparting rotary motion thereto, said first gear ring being fixed;
the first ring gear constitutes part of a cover member of the transmission mechanism;
the transmission mechanism can be configured for substantially reducing revolving speed imparted by the drive unit in order to obtain substantially high momentum in order to render the system compatible for operating at substantially rough conditions (e.g. dirt in the filtered fluid), whilst on the other hand obtaining a substantially low transmission ratio in order to cut waste water during a cleaning/rinsing procedure;
if required revolution reduction ratio takes place in several stages;
furthermore, gear ratio change can take place manually or automatically;
according to a particular example the first ring gear constitutes part of a cover member of the transmission mechanism.
the at least one cleaning system can be configured as a jet system configured for applying jets of fluid against a surface of the filtration units;
the at least one cleaning system can be configured as a suction system configured for applying suction over a surface of the at least one of the plurality of filtration units;
either one of the plurality of filtration units and the at last one cleaning system can be static whilst the other of said plurality of filtration units and at least one cleaning system can displace in rotatable and/or linear motion, or both of the plurality of filtration units and the at least one cleaning system can displace revolvingly and/or linearly;
at least one of the plurality of filtration units is in the form of a cylindrical cartridge;
at least one of the plurality of filtration units comprises disc filters;
at least one of the plurality of filtration units comprises a thread filter;
at least one of the plurality of filtration units is a screen filter;
the plurality of filtration units is parallely disposed within the housing;
each of the at least one cleaning system is coaxially disposed within each of the plurality of filtration units;
the at least one drive unit is a power motor or a hydraulic turbine or a hydraulic pump;
the plurality of filtration units are configured as one or more sub-assemblies comprising a plurality of parallely disposed filtration units, each sub-assembly being configured with at least one drive unit and a transmission mechanism in conjunction with the at least one drive unit, and being configured for displacement of one or both of said filtration units and cleaning system with respect to the other of said filtration units and cleaning system within each of the one or more sub-assemblies;
displacement of the plurality of filtration units and cleaning system can be either or both rotatable (revolving) and linear motion, imparted to either or both, simultaneously or separately. Accordingly, either or both of the plurality of filtration units and cleaning system can be static whilst the other of said plurality of filtration units and cleaning system can displace in revolvingly and/or linearly, or both of the plurality of filtration units and cleaning system can displace revolvingly and/or linearly;
displacement of the filtration units and cleaning system can be reciprocal (linear and revolvingly) or continuous (revolvingly);
a filtration unit used in conjunction with a filter system according to the disclosed subject matter is of any type e.g. disc filters, thread filters, solid filters, screen filters, etc., and typically is in the form of a cylindrical cartridge;
reciprocal motion can be obtained by alternating direction of rotary motion imparted by the drive unit or by a rotary direction inverting mechanism;
a rotary direction inverting mechanism can be a threaded guide rod configured with several high pitch threads and a stationary nut mounted thereon. Other direction inverting mechanisms are for example a piston or an ascending gear wheel mechanism.
The cleaning system (also referred to as a rinsing system) can be a jet system configured for applying jets of fluid against a surface of the filtration units, or a suction system configured for applying suction (vacuum) over a surface of the filtration units;
according to a particular example, the cleaning system can be configured for applying the rinsing jets and suction force in combination or alternatingly;
the filter system can be configured for substantially reducing overall friction within the system by reducing rotary friction. For that purpose, axial forces on revolving members can be significantly reduced or eliminated, with friction resident substantially in sealing gaskets;
cleaning of the plurality of filtration units requires efficient screening of a surface of the filtration units, i.e. substantially full surface coverage of the jet nozzles and/or suction cups over said surfaces;

### BRIEF DESCRIPTION OF THE DRAWINGS

In order to better understand the subject matter that is disclosed herein and to exemplify how it can be carried out in practice, embodiments will now be described, by way of non-limiting example only, with reference to the accompanying drawings, in which:

FIGS. 1A to 1F are directed to a filtration system in accordance with an example of the present disclosed subject matter, wherein:

FIG. 1A is a top perspective view of the filtration system;

FIG. 1B is a horizontal section along line A-A in FIG. 1A;

FIG. 1C is a longitudinal section along line B-B in FIG. 1A;

FIG. 1D is a longitudinal section along line C-C in FIG. 1A;

FIG. 1E is a top view illustrating in further detail a drive unit and transmission mechanism used in the filtration system of FIG. 1;

FIG. 1F is a detailed view of a sectioned top portion of the filtration system;

FIG. 1G illustrates a sectioned top portion of a filtration system according to a modification, directed to a particular transmission mechanism;

FIG. 2A is a top isometric view of a second example of a filtration system in accordance with another example of the present disclosed subject matter being a so-called partial in-line configuration, wherein a body portion is made translucent for visualization;

FIG. 2B is a top isometric view of a filtration system being a so-called in-line filtration system, wherein a body portion is made translucent for visualization;

FIG. 3 is directed to still an example of the filtration system in accordance with the disclosed subject matter, being a top perspective view of which a portion of the housing is made translucent for illustrative purposes;

FIGS. 4A to 4D schematically presents a filtration system in accordance with the disclosed subject matter wherein a liquid drive unit is associated with each filtration unit/cleaning system, wherein:

FIG. 4A is a perspective view of the filtration system, at its filtering position;

FIG. 4B is a longitudinal planner view of FIG. 4A;

FIG. 4C is a perspective view of the filtration system at its cleaning position;

FIG. 4D is a planar sectioned view of FIG. 4C;

FIG. 5 is a perspective view illustrating a filtration system in accordance with yet an example of the disclosed subject matter wherein a central turbine is configured for propelling the filtration unit/cleaning system, wherein the system is illustrated at a filtering position;

FIG. 6 is a perspective view illustrating a filtration system in accordance with still an example of the disclosed subject matter wherein each filtration system/cleaning system is configured with a hydraulic turbine, the system being illustrated at a filtering position;

FIGS. 7 to 10 illustrate transmission mechanisms in accordance with examples of the present disclosed subject matter, wherein:

FIGS. 7A and 7B are a top and bottom perspective view, respectively, of a first transmission mechanism;

FIGS. 8A and 8B are a top and bottom perspective view, respectively, of a second transmission mechanism;

FIGS. 9A and 9B are a top view and sectioned view along line A-A in FIG. 9A, respectively, of yet an example of t a transmission mechanism; and

FIGS. 10A and 10B are top and bottom perspective views, respectively of even yet an example of t a transmission mechanism.

### DETAILED DESCRIPTION OF EMBODIMENTS

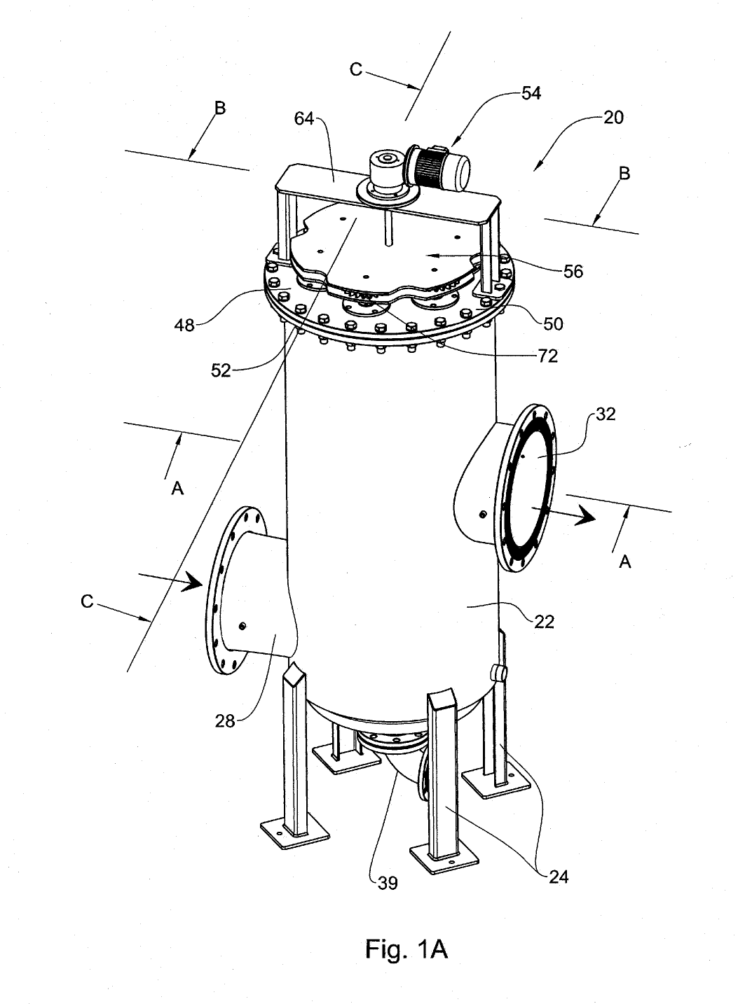

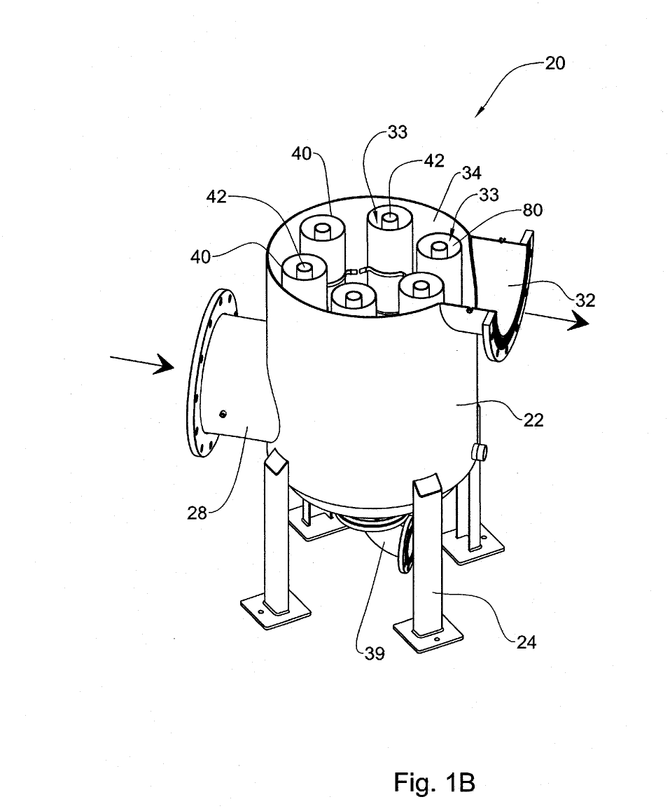

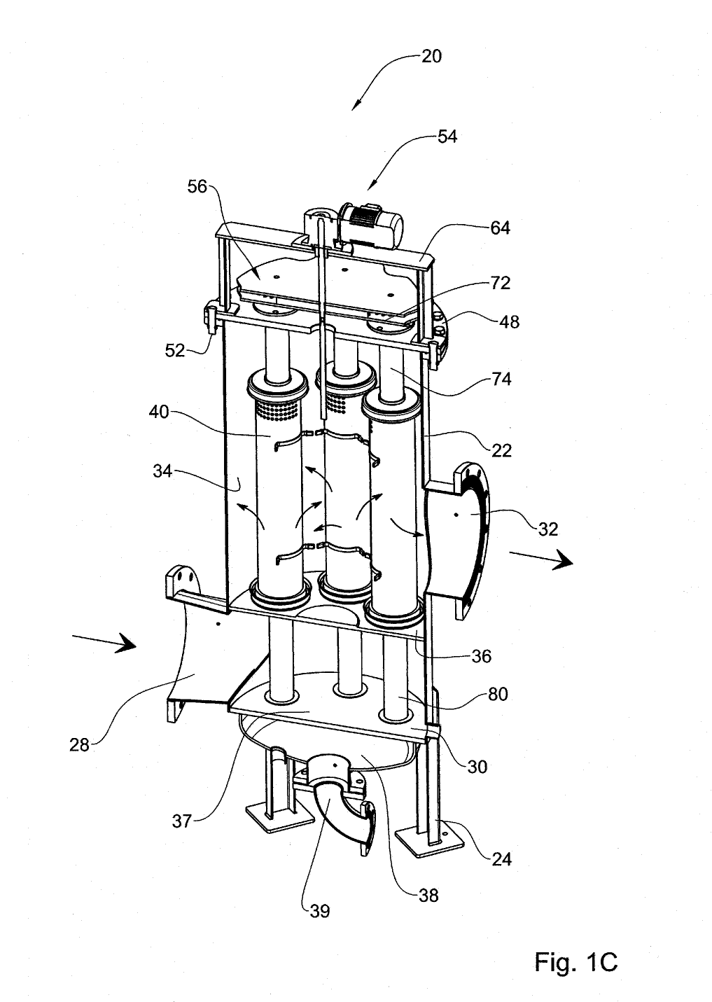

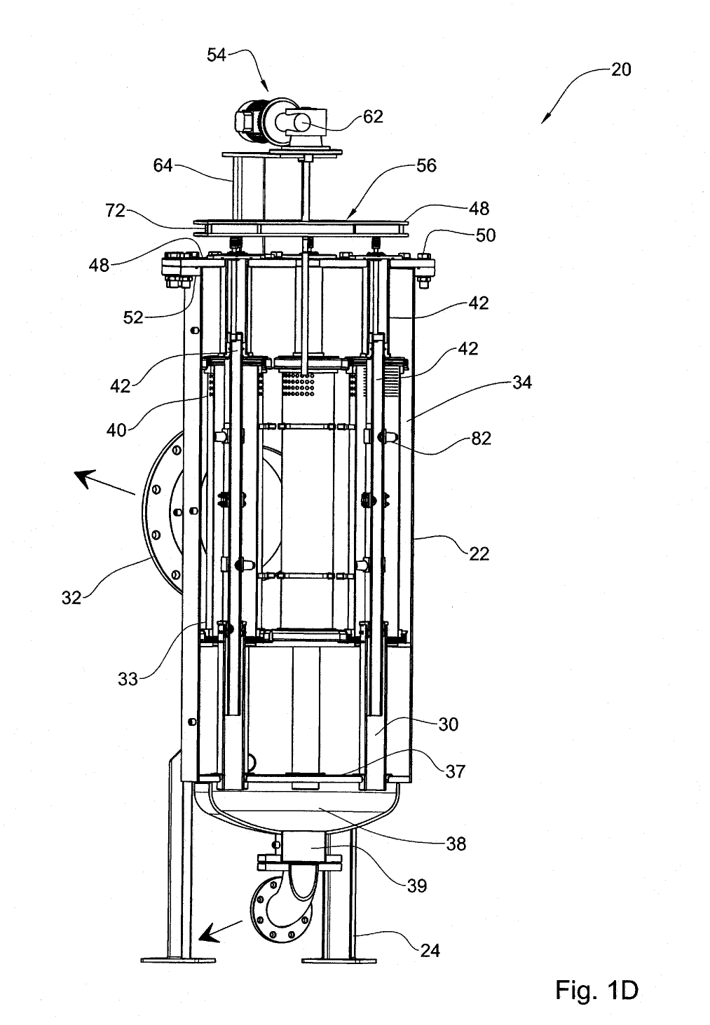

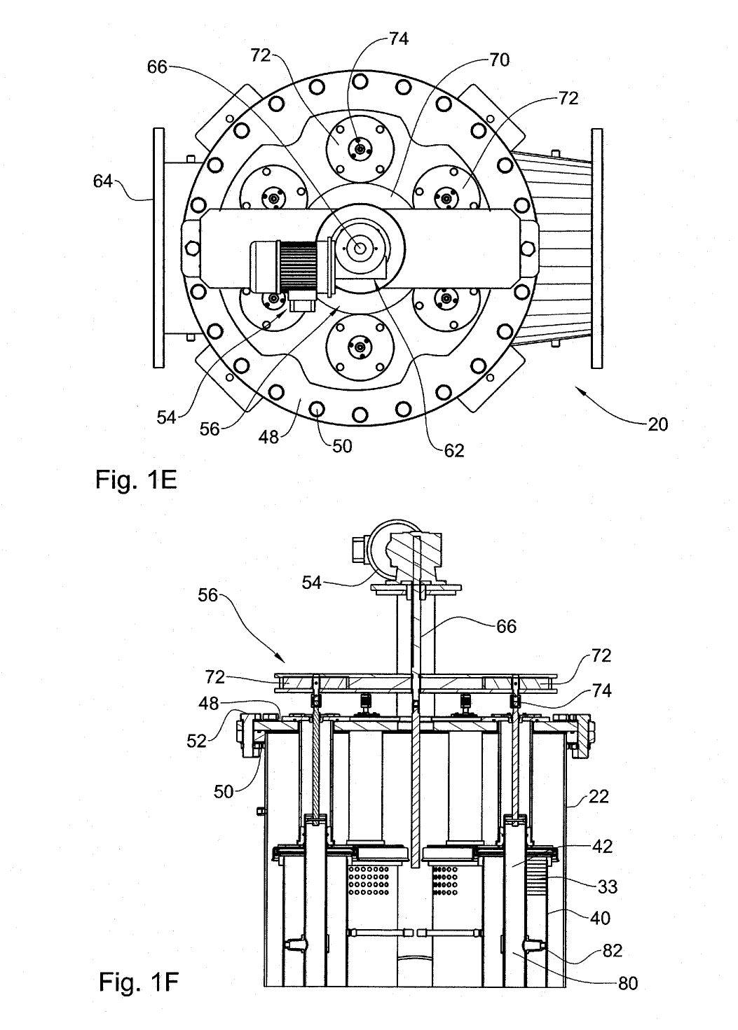

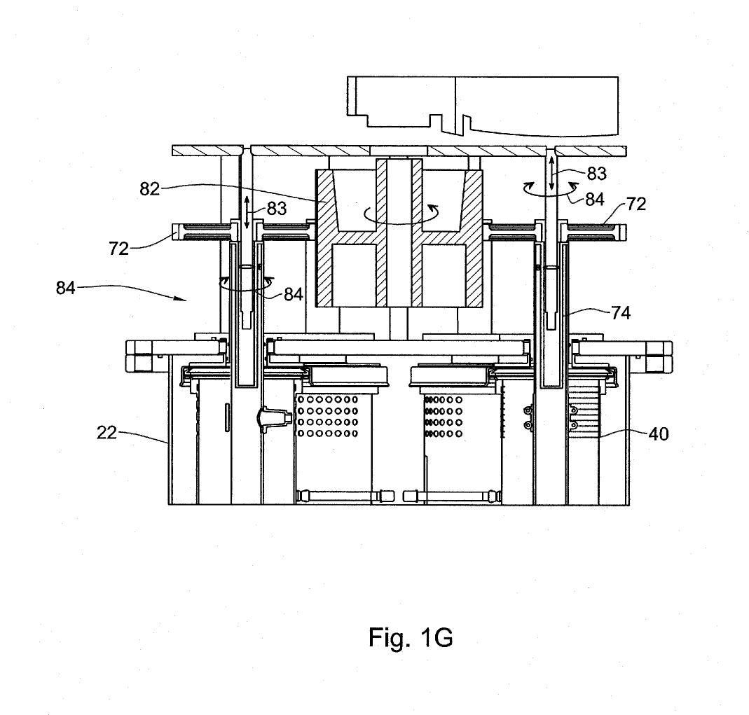

Attention is first directed to FIGS. 1A to 1E of the drawings illustrating a filtration system in accordance with a first example of the present disclosed subject matter, generally designated 20. The filtration system 20 is a so-called ‘partial in-line’ filtration system, comprising a cylindrical housing 22 mounted over support legs 24 and comprising an inlet port 28 extending into a filter inlet space 30 within the housing 22, and an outlet port 32 extending from a filtration space 34. The filter inlet space 30 and the filtration space 34 are partitioned by a first partition member 36, whilst a second partition member 37 partitions between the filter inlet space 30 and a filtrate drain space 38 configured with a drain port 39.

The filtration space 34 accommodates a plurality (six in the present example) of stationary (rotatably fixed) filtration units 40, being hollow cylindrical filtration cartridges, e.g. solid filtration cartridges, disc cartridges, mesh filtration cartridges, etc. it is however appreciated that, throughout the present disclosure, a filtration unit can be of any type. Coaxially received within each of the filtration units 40 there is a cleaning system 42, as will be discussed hereinafter in further detail.

Housing 22 is configured with a top cover 48 secured by a plurality of bolts 50 to a flange 52 configured at a top edge of the housing 22. Mounted over the top cover 48 there is a drive unit generally designated 54 and a transmission mechanism generally designated 56, to be discussed hereinafter with more detail.

In the present examples the drive unit 54 is an electric motor (though other motors are possible too, e.g. a hydraulic motor, pneumatic motor, etc.) coupled via a transmission gear 62 and extending over a support bridge 64. The transmission gear 62 is configured for converting rotary motion of the motor axis into rotary motion at a substantially perpendicular axis. Said perpendicular axis being a central input axis 66 extending coaxially into the housing 22 of the filtration system 20 and articulated with the transmission mechanism 56 for imparting rotary motion to a central gear 70, the latter engaged with a plurality of pinion gears 72, each mounted at a top end of a cleaning tube 74 of each of the cleaning systems 42, as will be discussed hereinafter. The transmission gear 62 is also configured for imparting rotary motion and reciprocal axial motion to the central input axis 66, and the electric motor is fitted with an electric circuitry for rotating it alternately in opposite directions during the cleaning stage.

Each cleaning system 42 is configured with a central pipe/tube 80 (also referred to as cleaning pipe/tube) provided with a plurality of jet emitting nozzles 82 spaced along the tube 80 and extending in close proximity to an inside face of the filtration unit, said tube 80 extending through the filter inlet space 30 in a sealed fashion (i.e. the cleaning tubes 80 sealingly extend through said filter inlet space 30), wherein the tubes 80 open into the filtrate drain space 38. The tubes 80 extend out of the filtration unit 40, through sealed passages within the top cover 48 and are coupled to rinsing fluid supply ducts (not shown) articulated thereto.

The arrangement is such that at a filtration position of the filtration system 20 raw fluid enters the filter inlet space 30 through inlet port 28 and then enters into the filtration space 33 within each filtration unit 40 whereupon the fluid is filtered and a filtered fluid thus flows into the filtration space 34 from where it is collected through the outlet port 32. In this position there is no fluid flow through the tubes 80 of the cleaning system and the drain port 39 is sealed.

At a cleaning/rinsing position a rinsing fluid is propelled through the top of the cleaning system tubes 80 whilst electric motor 54 rotates. Rotation of the electric motor 54 results in corresponding rotation of the cleaning pipe 80, though at significantly reduced speed, and with corresponding axial displacement of the entire transmission mechanism 56, owing to reciprocal linear motion imparted thereto via the gear mechanism 62, wherein a jet of rinsing fluid is applied through each of the jet nozzles 82 and impinges against the inside surface of the filtration units 40, said rinsing jet screening effectively along the inside surface of the filtration units, i.e., covering substantially the entire inside surface thereof, wherein the rinsing fluid together with the filtrate (waste water together with dirt accumulated over the walls of the filtration unit) drain into the filtrate drain space 38 and are allowed out through the drain port 39.

It is however appreciated that according to a modification (not shown) of the disclosure referred to in FIGS. 1A to 1F, filtration can take place radially into the filtration units (i.e. in direction from the filtration space 34 into the filtration units 40), whereupon a cleaning/rinsing procedure takes place by a jet of fluid applied on the inside surface of the filtration unit (i.e. radially outwards).

It is further appreciated that a cleaning/rinsing procedure can take place by a combined jet rinsing and suction applied over the surface of the filtration unit.

The illustration of FIG. 1G illustrates a transmission mechanism generally designated 81 and fitted externally, on top of the housing 22. A power input shaft is coupled to a central input gear 82 axially fixed (i.e. non displaceable in an axial direction, but only free to rotate) which in turn is coupled to three pinion gears 72 (similarly to the configuration disclosed in FIG. 1E). Each of the pinion gears is rotatably mounted on a threaded axle. However, input gear 82 is significantly thicker (higher) than the pinion gears 72 engaged therewith, and wherein rotation of the pinion gears 72 over the input gear 82 generates a combined axial reciprocal motion of the pinion gears 72 about their axes, as represented by arrows 83, and reciprocal (or not) revolving motion as represented by arrows 84. Axial reciprocal displacement of the pinion gears 72 entails corresponding axial displacement of the cleaning tubes 74 articulated thereto.

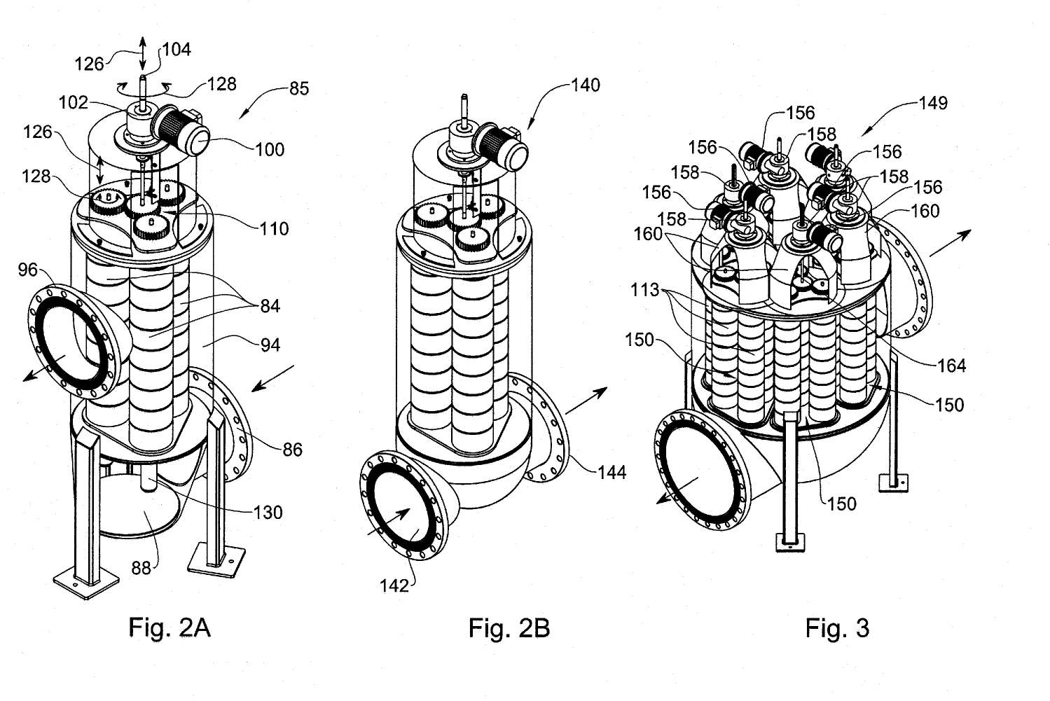

The example illustrated in FIG. 2A resembles that illustrated in connection with FIGS. 1A to 1F in that it is a so-called partial in-line configuration filter system designated 85, wherein the inlet port 86 and outlet port 96 are not coaxial. However, in the present example it comprises only three filtration units, each designated 84 and extending within the housing in a symmetrical fashion.

In a filtration process according to the example of FIG. 2A raw fluid flows through the inlet port 86, into an inlet space 88, then into the filtration space within each of the filtration units 84, wherein the fluid is filtered and whereby filtered fluid now flows into the filtration space 94 and out through the outlet port 96.

During a rinsing process the electric motor 100 revolves and imparts alternatingly rotational motion to the gear system 102 which on the one hand converts rotary motion of the motor 100 into rotary motion about a central axis perpendicular to that of the motor, and on the other hand imparts reciprocal axial motion to the threaded rod 104 which serves as an input shaft for the transmission mechanism generally designated 110.

Thus, during a rinsing/cleaning procedure, a rinsing fluid is introduced into the cleaning tubes (parallely disposed within the filtration units 84; not seen) resulting in fluid jets immersing through jet nozzles of the cleaning tubes extending in close proximity with an inside surface of the filtration units 84, whereby cleaning fluid and dirt drains down to the bottom chamber 88 (now disconnected from a raw fluid supply line and serving as a drain port).

As can be seen in FIG. 2A, the transmission mechanism 110 is configured for imparting the rinsing tube with linear reciprocal motion as indicated by arrowed line 126, and combined reciprocal rotary motion, as illustrated by arrowed lines 128, thereby reaching optimal rinsing of the filtration units 84 by the fluid jets reaching substantially the entire inside surface of the filtration units 84. As mentioned hereinabove, rinsing jets can be replaced, or accompanied by suction cleaning force applied over the surface of the filtration units.

It is appreciated that each of the rinsing tubes (not seen) is received within a support tube 130 extending into the filter inlet space 88 thus isolating the cleaning tube 120 from the filter inlet space 88 and for supporting said cleaning tube whilst facilitating its reciprocal linear and reciprocal motion about a longitudinal axis thereof.

The example illustrated in FIG. 2B is substantially similar to that disclosed in connection with FIG. 2A, however being a so-called ‘in-line’ back-flush filtration system 140 wherein the inlet port 142 extends substantially coaxial with the outlet port 144. Thus, the configuration of FIG. 2B requires suitable fluid flow diverting means received within the bottom housing compartment 146, to facilitate fluid flow between the inlet port 142 and outlet port 144, during the filtration/rinsing procedures. Apart for this difference, the example of FIG. 2B is similar in construction and principle operation to that disclosed in connection with that of FIG. 2A.

The filtration system 149 illustrated in FIG. 3 is based on the principles discussed hereinabove in connection with the previous examples, however where the filtration units are grouped into sub-assemblies each designated 150 and each composed of a cluster holding three filtration units 152 disposed in a triangular configuration and extending parallel to one another. Furthermore, each sub-assembly 150 is configured with an independent drive unit, namely motor 156, each associated with a motion converting gear unit 158 mounted over a domed bridge 160 and articulated to a transmission mechanism 164 as discussed hereinbefore in connection with the previous examples.

Operation of the large scale filtration system of FIG. 3 takes place similarly to the disclosure hereinbefore, however in larger volumetric scale.

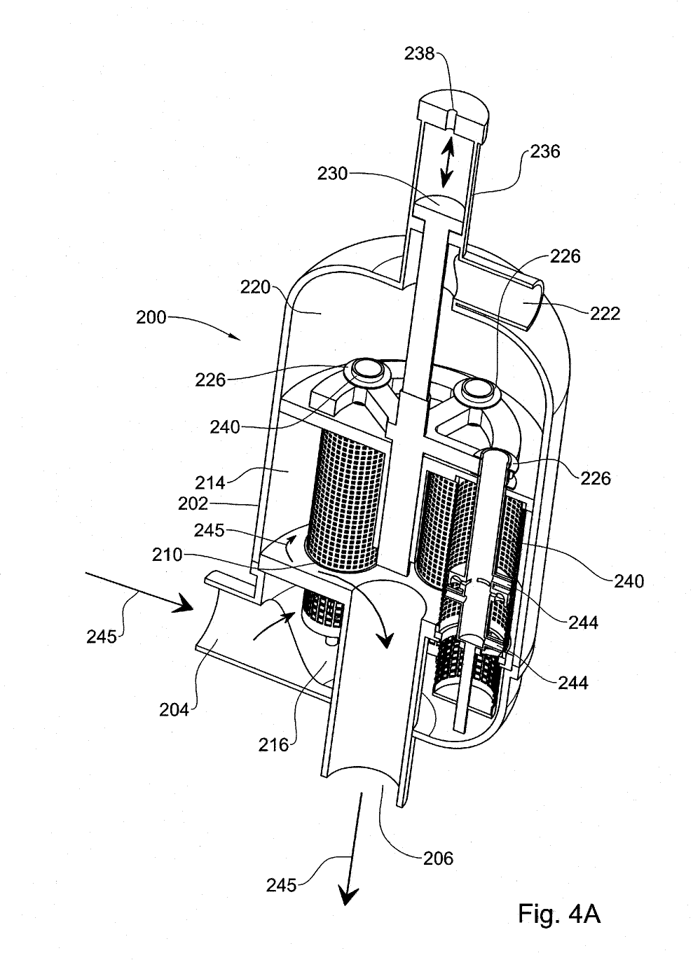

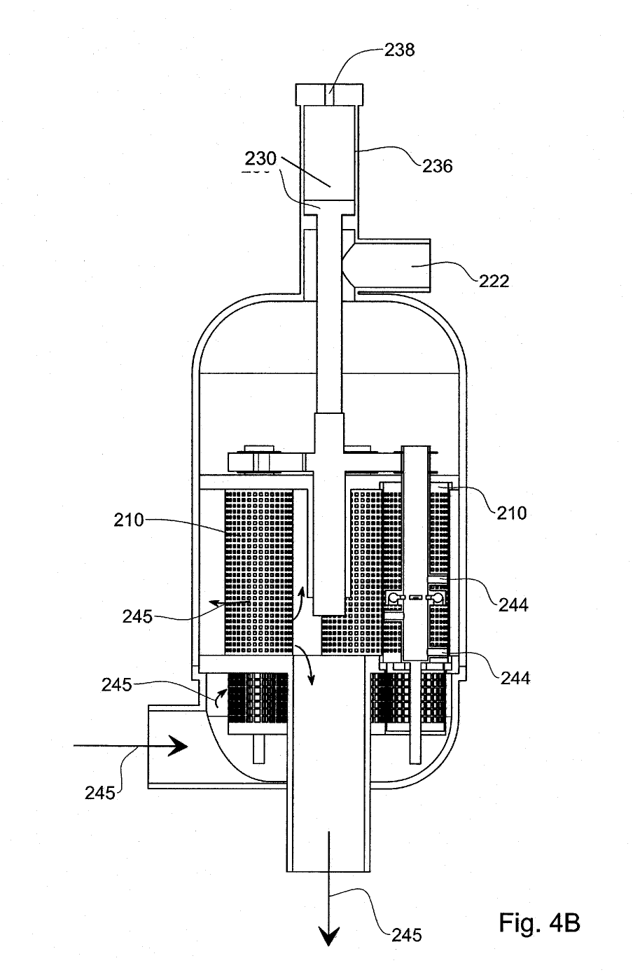

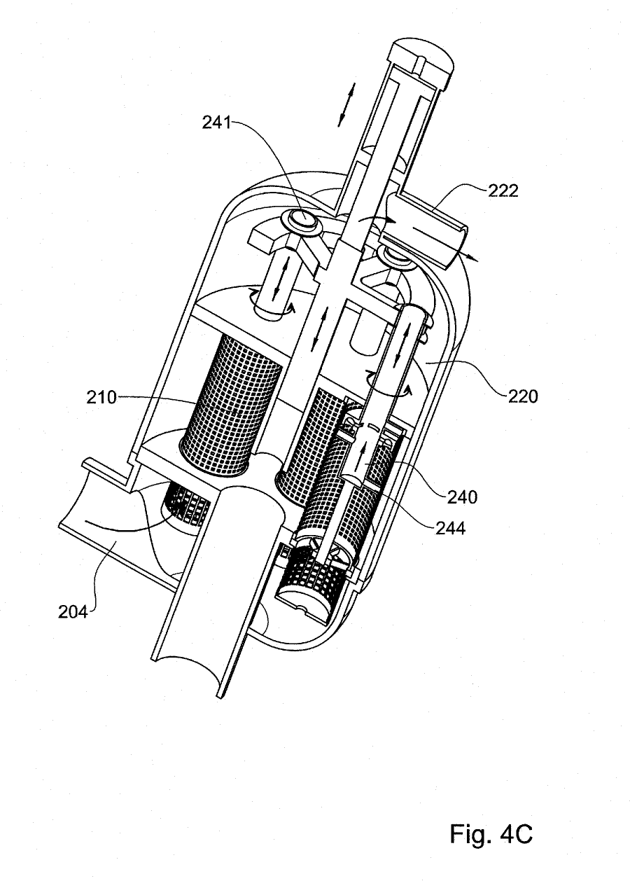

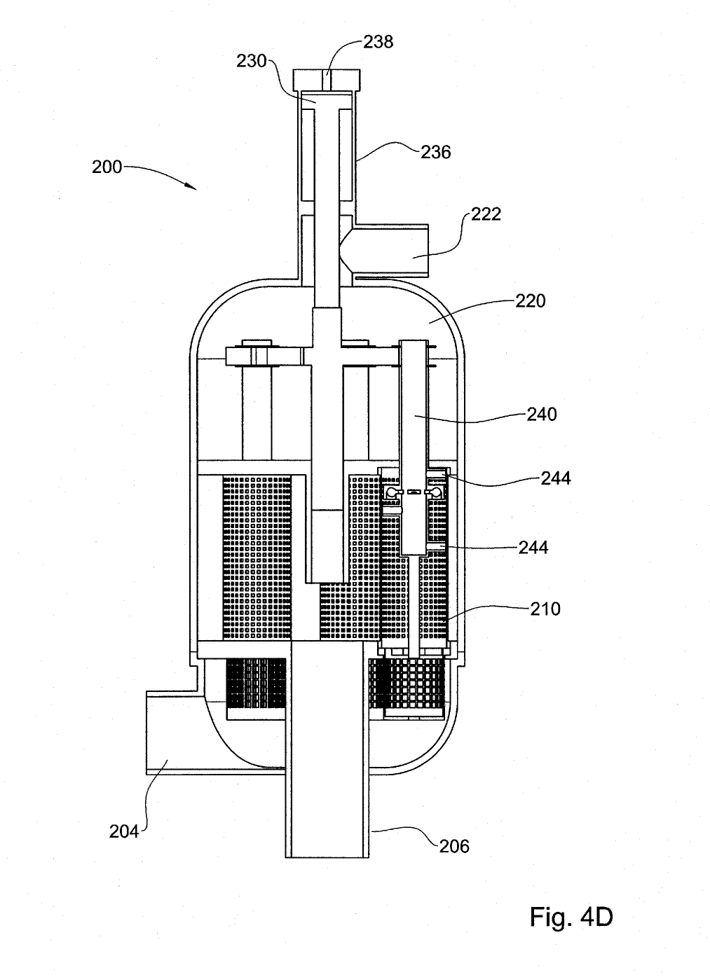

Turning now to FIGS. 4A to 4D there is illustrated a filtration system in accordance with yet a modification of the present disclosed subject matter, generally designated 200, wherein the housing 202 is configured with an inlet port 204 and an outlet port 206 and a plurality of filtration units (five in the present example, though only three of which are seen in the sectioned view) and designated 210, symmetrically disposed within the housing 202 with their longitudinal axis parallelly disposed within the housing 202.

The housing 202 is configured with a filtration space 214 accommodating said filtration units 210, a filter inlet space 216 extending below said filtration space 214, and a top chamber 220 configured with a drain fluid outlet port 222 and accommodating a drive unit 226, each associated with a filtration unit 210. The drive units 226 are so-called hydraulic motors configured for generating rotary motion and further fitted with a central piston assembly 230 reciprocally linearly displaceable within a vented piston support housing 236 with a venting port 238.

The piston 230 is for example a hydraulic piston configured with one or two side controls (i.e. retract and/or expand activators).

Extending from the top chamber 220 there are a plurality of cleaning/rinsing units in the form of tubes 240, each associated with a filtration unit 210, said cleaning tubes extending from the top chamber 220 through each of the filtration units 210 and down into the inlet space 216. Each of the tubes 240 is configured with a plurality of suction cups/nozzles 244 radially extending in close proximity with the inside surface of the filtration units 210.

The arrangement being such that the cleaning tubes 240 are linearly and rotatably reciprocal, in a combined motion, within the space of the filtration units 210, and thus configured for effective and efficient screening and suction of the entire inside surface of the filtration units 210.

During a filtration mode of the filtration system 200 (FIGS. 4A and 4B), raw fluid enters through the inlet port 204 and enters the inside surface of the filtration units 210 where it is filtered and then exits through the filtration space 214 and then exits through the outlet port 206 as illustrated in these drawings by arrowed lines 245.

During a filtration process the drain fluid outlet port 222 is closed and during the rinsing process drain fluid outlet port 222 opens.

In a rinsing/cleaning mode, FIGS. 4C and 4D, suction is applied through the inlet port 204 and then into the rinsing tubes 240 resulting in rinsing jets applied through the jet applying nozzles 244 against the inside surface of the filtration units 210, wherein the dirty waste fluid (filtration fluid with dirt) exits through the top openings 241 of the tubes 240, into the top chamber 220 and then egresses through the drain fluid outlet port 222.

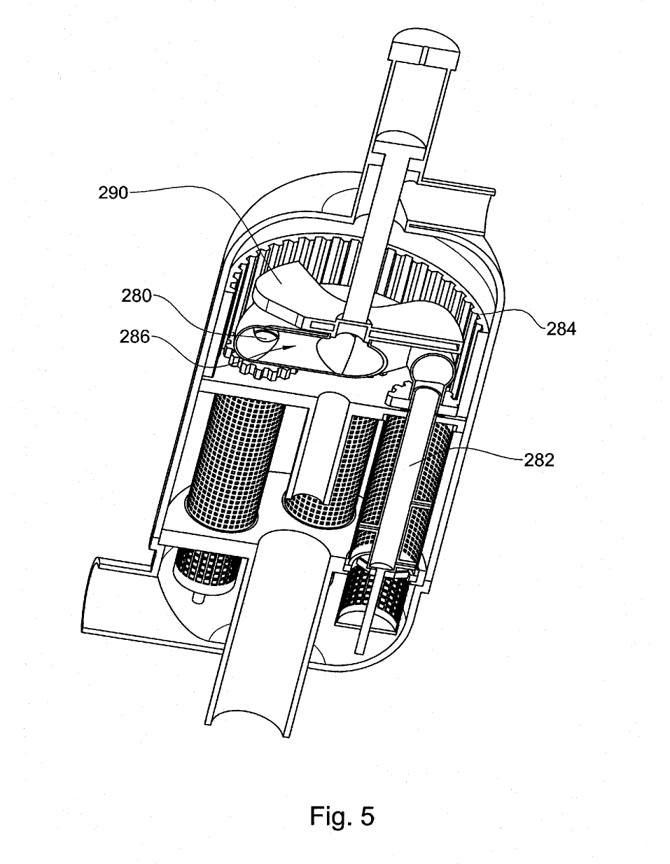

Whilst in the example illustrated with reference to FIGS. 4A to 4D the drive unit articulated with the cleaning assembly is a liquid-operated motor (“hydraulic motor”), in the example illustrated in FIG. 5 the drive unit is a central turbine designated at 280 configured for generating rotary motion and distribution of said rotary motion to each of the rinsing tubes 282 by virtue of a gear system comprising a peripheral geared ring 284 engaged with a plurality of gearings 286 each associated with a cleaning tube 282. The geared ring 284 extends along a significant portion of the top chamber 290 whereby the turbine 280 and the articulated gear 286 are free to axially displace therein between a downward position and an uppermost position during the rinsing position.

Apart for this difference, the examples of FIGS. 4 and 5 operate in the same manner during a filtering stage and a rinsing/cleaning stage and reference is made to FIG. 4 above for understanding how these stages take place.

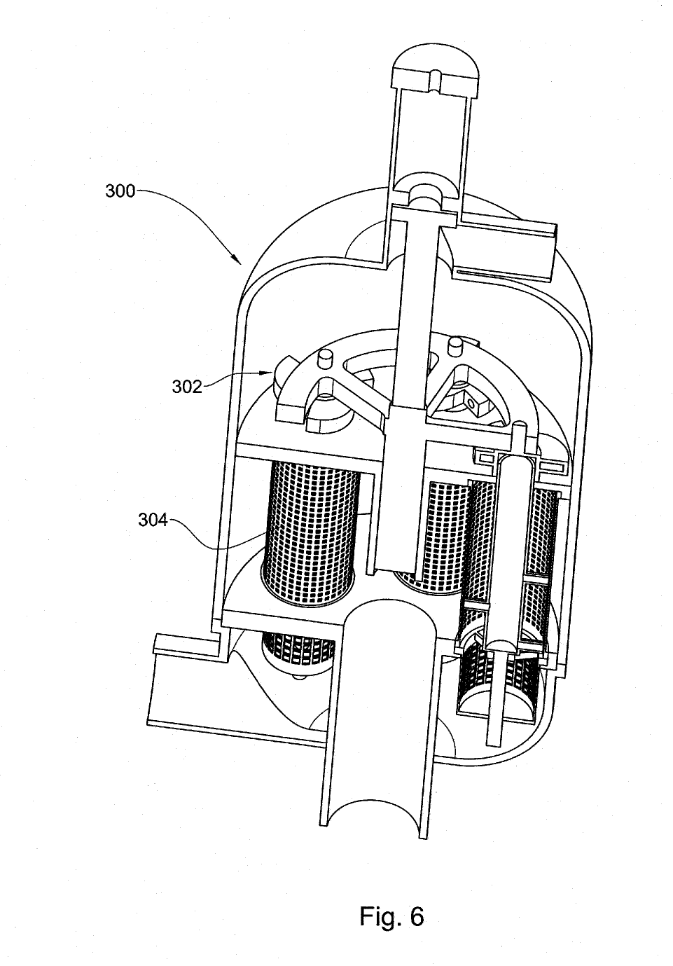

Likewise, FIG. 6 illustrates yet an example of a filtration system in accordance with the disclosed subject matter generally designated 300 the difference residing in that rather than a central turbine as disclosed in connection with FIG. 5 there is provided a separate turbine unit 302 articulated with each filtration unit 304 and serving as an independent drive unit therefor.

Other than this difference, operation of the filtration system 300 is similar to that disclosed in connection with the examples of FIGS. 4 and 5 during their filtration stage and rinsing/cleaning stage and reference is made thereto.

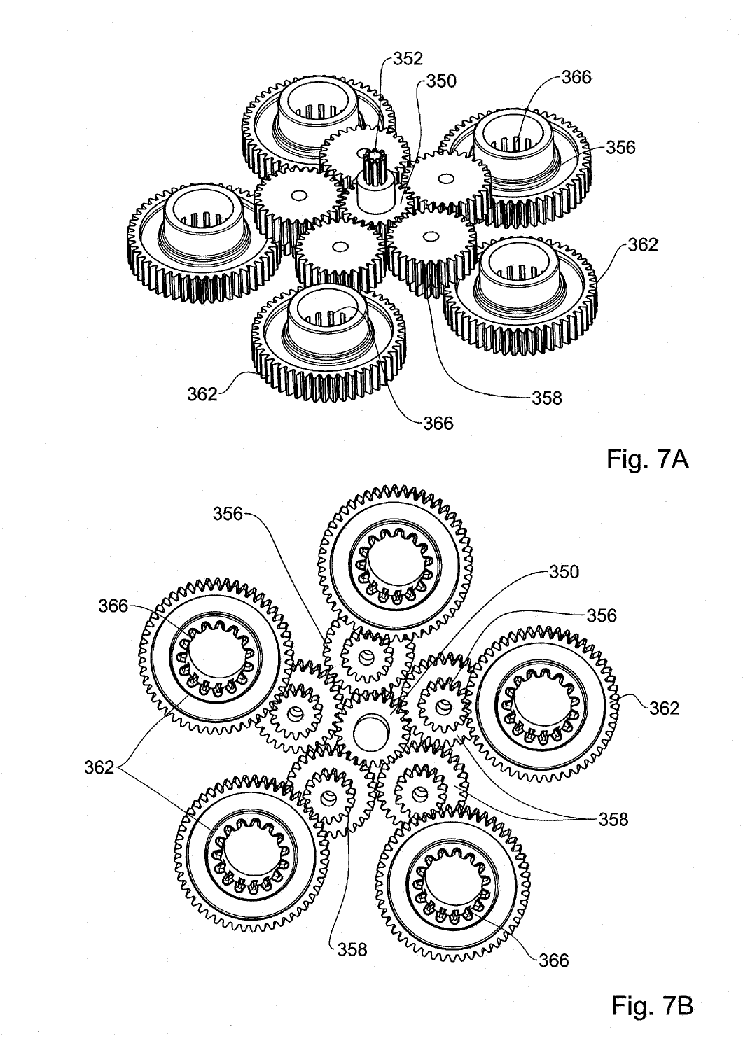

FIGS. 7 to 10 are directed to different examples of transmission mechanism that are useful in connection with filtration systems in accordance with the present example. Turning first to FIGS. 7A and 7B there is illustrated a gear transmission configured with an input gear 350 configured for coupling to an input shaft of a drive unit by cogged shank portion 352. The input gear 350 is engaged with a plurality of first pinion gears 356 (five in the present example) each integral with and coaxially extending with a second level of gears 358 which in turn are engaged with second pinion gears 362. The arrangement is such that input gear 350 has a smaller diameter than that of first pinion gears 356 which have a larger diameter than the engaged gears 358 which in turn are significantly smaller than the second pinion gears 372, thereby obtaining significant speed reduction throughout the transmission assembly. Second pinion gears 362 are engaged with the tubular rinsing members (not shown) by virtue of internally geared portion 366.

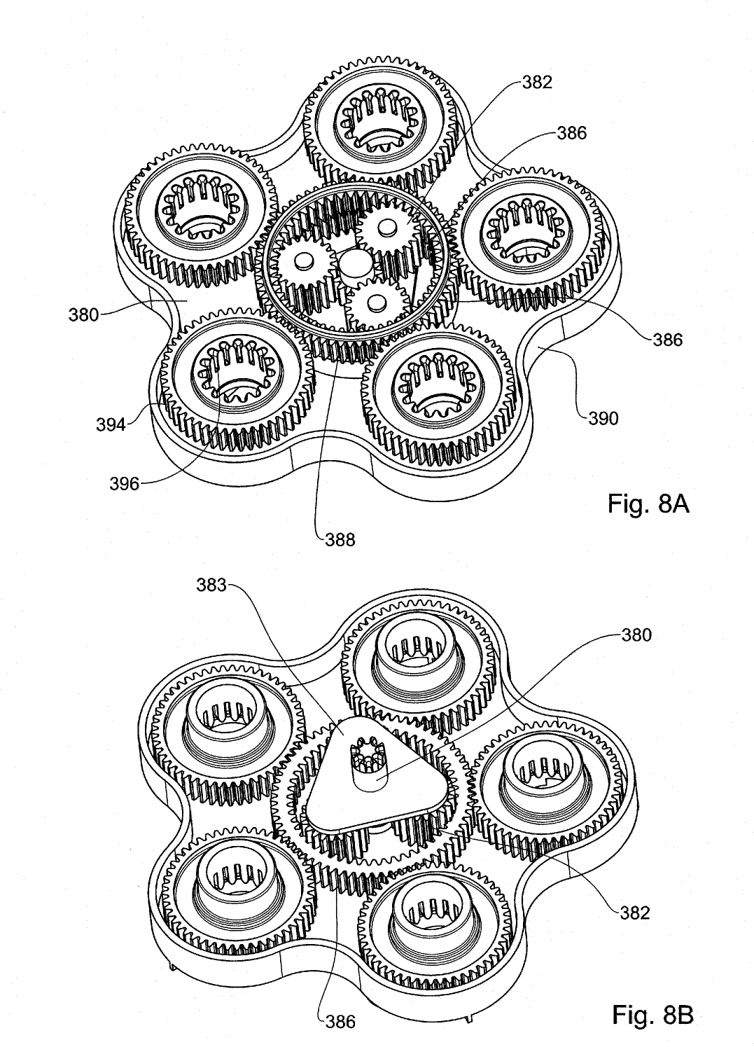

In the example of FIGS. 8A and 8B there is illustrated a different example wherein a sun gear 380 is configured for coupling to an input shaft of a drive unit (not shown) which in turn said sun gear 380 is engaged with three first pinioned gears 382, mounted over a carrying triangular plate 383 at a fixed planetary configuration, engaged for rotation with a geared ring 386 constituting part of a cover portion 390 for said transmission mechanism, i.e. being fixedly articulated and non-rotatable. In turn, the gears 382 are engaged with an internally and externally geared ring 388 which is engaged, through its external geared portion with second pinion gears 394, each of which being coupled to a rinsing tube (through an internally cogged portion 396) for imparting said tube (not shown) rotary motion during a rinsing/cleaning process.

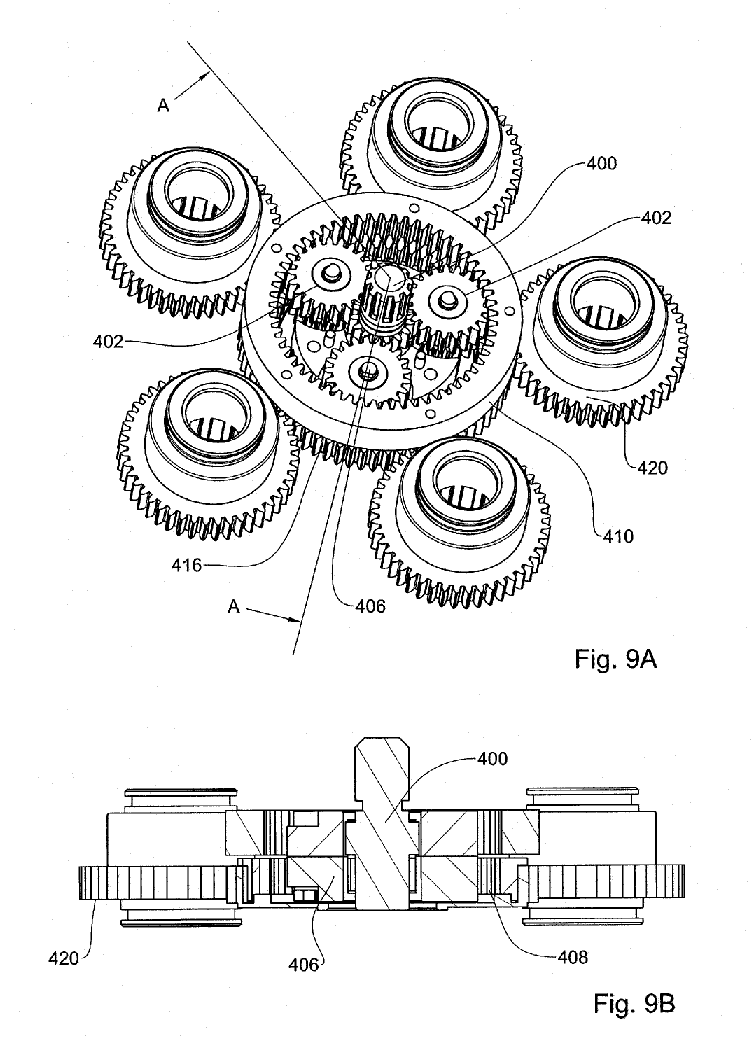

Turning now to FIGS. 9A and 9B there is provided a pinion gear 400 configured for coupling to an input shaft of a drive unit (not shown) and engaged with three first pinions 402 each of which pivotally mounted on an axel 406 projecting from a carrying plate 408. First pinions 402 are engaged with an inner geared ring 410 which is static, i.e. fixedly secured to a housing component of the filtration unit, with a second gear 412 coaxially extending below each first pinion 402 and engaged in turn with an internally and externally geared ring 416 which in turn is engaged with a plurality of second planetary gears 420 (5 in the present example) each of said second pinion gears 420 being coupled to a rinsing tube (not shown) for imparting thereto rotary motion.

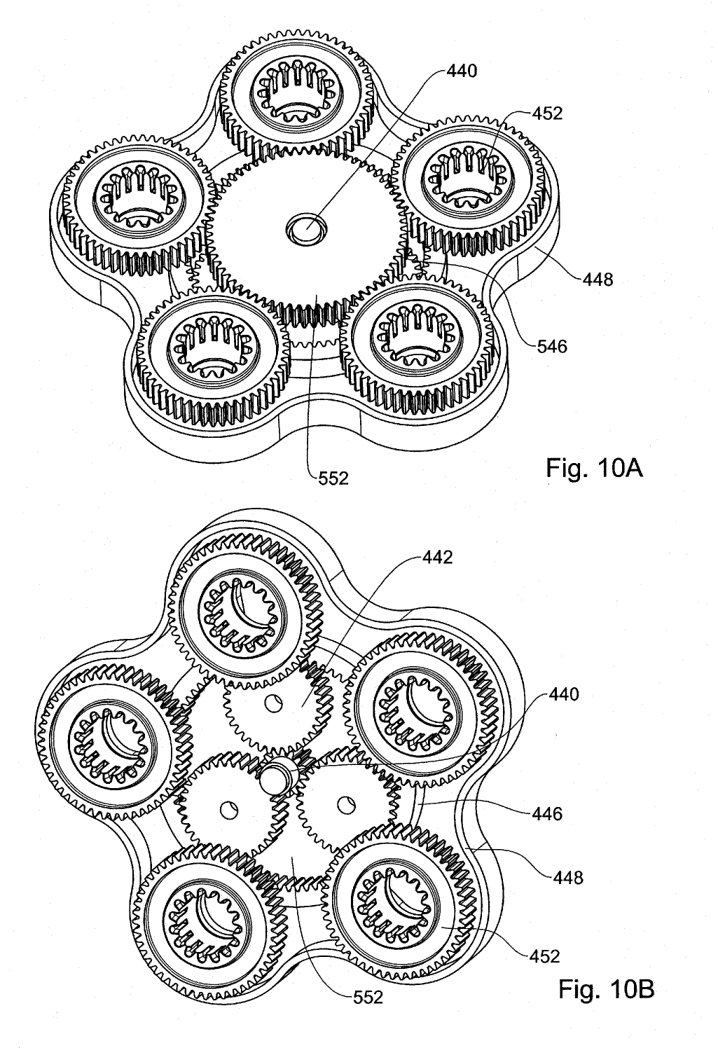

The example illustrated in connection with FIGS. 10A and 10B resembles that of the example of FIGS. 9A and 9B and comprises an input sun gear 440 configured for coupling to an input shaft of a drive unit (not shown) and which in turn is engaged with three first planetary gears 442, each of which being internally engaged with an internally geared static ring 446 (being part of a cover assembly 448 of the transmission mechanism). Second planetary gears 452 are engaged in turn with a central geared disc 552 carrying the first pinions 452 in a planetary motion.

Whilst several particular examples of gear transmissions have been exemplified, it is to be realized that different configurations and combinations can be designed, without departing from the scope of the disclosed subject matter. For example, revolution reduction ratio can take place in several stages and furthermore, gear ratio change can take place manually or automatically.

1.-26. (canceled)

27. A filtration system, comprising:
a filter housing comprising an inlet port and an outlet port;
a plurality of filtration units disposed within the filter housing;
at least one cleaning system configured for cleaning at least one filtration unit of the plurality of filtration units; and
at least one drive unit, wherein the at least one drive unit is configured for displacing one or both of said at least one filtration unit of the filtration units and the at least one cleaning system with respect to the other of said at least one filtration unit of the filtration units and said at least one cleaning system.

28. The filtration system in accordance with claim 27, wherein displacement of said at least one filtration unit of said plurality of filtration units and said at least one cleaning system can be either or both rotatable and linear motion, imparted to either one or both of the at least one filtration unit of the plurality of filtration units and the at least one cleaning system, simultaneously or separately.

29. The filtration system in accordance with claim 27, further comprising a transmission mechanism associated with the at least one drive unit.

30. The filtration system in accordance with claim 27, further comprising a transmission mechanism associated with the at least one drive unit wherein the transmission mechanism is configured for imparting the at least one cleaning system with linear reciprocal motion and combined reciprocal rotary motion.

31. The filtration system in accordance with claim 27, further comprising a transmission mechanism associated with the at least one drive unit, the transmission mechanism being configured for converting motion from said at least one drive unit to the at least one of the plurality of filtration units and the at least one cleaning system.

32. The filtration system in accordance with claim 27, further comprising a transmission mechanism associated with the at least one drive unit wherein the transmission mechanism is a planetary gear configured with one or more speed reduction stages.

33. The filtration system in accordance with claim 27, wherein the at least one cleaning system comprises a central cleaning pipe configured with jet emitting nozzles spaced along the central pipe, the at least one cleaning system being configured to extend in close proximity to an inside face of at an least one filtration unit of the plurality of filtration units.

34. The filtration system in accordance with claim 27, wherein the at least one cleaning system is configured as a suction system configured for applying suction over a surface of the at least one of the plurality of filtration units.

35. The filtration system in accordance with claim 27, wherein either one of the plurality of filtration units and the at last one cleaning system can be static while the other of said plurality of filtration units and at least one cleaning system can displace in rotatable and/or linear motion, or both of the plurality of filtration units and the at least one cleaning system can displace revolvingly and/or linearly.

36. The filtration system in accordance with claim 27, wherein at least one of the plurality of filtration units is in the form of a cylindrical cartridge and wherein each of the at least one cleaning system is coaxially disposed within one or more of the plurality of filtration units.

37. The filtration system in accordance with claim 27, wherein at least one of the plurality of filtration units comprises any one of disc filters; a thread filter; or a screen filter.

38. The filtration system in accordance with claim 27, wherein each of the at least one cleaning system is coaxially disposed within one or more of the plurality of filtration units.

39. The filtration system in accordance with claim 27, wherein the plurality of filtration units are configured as one or more sub-assemblies comprising a plurality of parallel disposed filtration units, each sub-assembly being configured with at least one drive unit and a transmission mechanism in conjunction with the at least one drive unit, and being configured for displacement of one or both of said filtration units and cleaning system with respect to the other of said filtration units and cleaning system within each of the one or more sub-assemblies.

40. The filtration system in accordance with claim 27, further comprising a transmission mechanism associated with the at least one drive unit wherein the transmission mechanism is a planetary gear system configured with a sun gear mounted on an input shaft articulated to the at least one drive unit, said sun gear being engaged with a plurality of first pinion gears; said pinion gears being each articulated to a rotation shaft of at least one of the plurality of the filtration units or a cleaning system and configured for imparting rotary motion thereto.

41. The filtration system in accordance with claim 27, further comprising a transmission mechanism associated with the at least one drive unit wherein the transmission mechanism is a planetary gear system configured with a sun gear mounted on an input shaft articulated to the at least one drive unit, said sun gear being engaged with a plurality of first pinion gears; said pinion gears being each articulated to a rotation shaft of at least one of the plurality of the filtration units or a cleaning system and configured for imparting rotary motion thereto, wherein each of the plurality of first pinion gears is engaged with a corresponding second pinion gear coaxially extending and each engaged with third stage gear, each articulated to a rotation shaft of a filtration unit or a cleaning system and configured for imparting rotary motion thereto.

42. The filtration system in accordance with claim 27, further comprising a transmission mechanism associated with the at least one drive unit wherein the transmission mechanism is a planetary gear system configured with a sun gear mounted on an input shaft articulated to the at least one drive unit, said sun gear being engaged with a plurality of first pinion gears; said pinion gears being each articulated to a rotation shaft of at least one of the plurality of the filtration units or a cleaning system and configured for imparting rotary motion thereto, wherein the first pinion gears are internally engaged with a first, static ring gear and with a second gear ring which in turn is externally engaged second pinion gears, each articulated to a rotation shaft of the at least one of the plurality of filtration units or the at least one of the cleaning system and configured for imparting rotary motion thereto, said first gear ring being fixed.

43. The filtration system in accordance with claim 27, further comprising a transmission mechanism associated with the at least one drive unit wherein the transmission mechanism is a planetary gear system configured with a sun gear mounted on an input shaft articulated to the at least one drive unit, said sun gear being engaged with a plurality of first pinion gears; said pinion gears being each articulated to a rotation shaft of at least one of the plurality of the filtration units or a cleaning system and configured for imparting rotary motion thereto, wherein the first static ring gear constitutes part of a cover member of the transmission mechanism.

44. The filtration system in accordance with claim 27, further comprising a drain port configured to be closed during a filtration process and to be opened during a cleaning process when the at least one cleaning system is in operation.

45. A filtration system, comprising: a plurality of filtration units and at least one cleaning system, wherein one or both of said filtration units and the at least one cleaning system is displaceable with respect to the other of said filtration units and the at least one cleaning system, further comprising a transmission mechanism configured for converting motion from one or more drive units to the plurality of filtration units and the at least one cleaning system.

46. A transmission mechanism configured for converting motion from one or more drive units to a plurality of filtration units and at least one cleaning system wherein one or both of the plurality of filtration units and the at least one cleaning system is displaceable with respect to the other of said filtration units and the at least one cleaning system.
